(19) United States
(12) Patent Application Publication
(10) Pub. No.: US 2017/0320083 A1
(43) Pub. Date: Nov. 9, 2017

(54) SPRAYER NOZZLE WITH EMBEDDED BATTERY-OPERATED ULTRAVIOLET LIGHT(S)

(71) Applicant: CG&Hayward, LLC, Austin, TX (US)

(72) Inventor: Christina G. Hayward, Austin, TX (US)

(73) Assignee: CG&Hayward, LLC

(21) Appl. No.: 15/582,245

(22) Filed: Apr. 28, 2017

Related U.S. Application Data
(60) Provisional application No. 62/331,816, filed on May 4, 2016.
(60) Provisional application No. 62/417,716, filed on Nov. 4, 2016.

(51) Int. Cl. B05B 11/00; G01N 21/88; G01N 21/94

(52) U.S. Cl. CPC B05B 11/3042; G01N 21/94; B05B 11/3057; G01N 21/8803; G01N 2201/062

(57) ABSTRACT

A spray nozzle for dispensing cleaning solution including embedded, battery-powered ultraviolet lights is disclosed. This invention improves the detection of contaminants that need to be removed or cleaned and obviates the need to locate a separate UV light in flashlight form. In addition, this invention maintains the traditional shape of a spray bottle and nozzle without adding any cumbersome elements that would make cleaning difficult.

### CROSS-REFERENCE TO RELATED APPLICATIONS

The present application claims priority to U.S. Provisional Application No. 62/331,816, filed May 4, 2016, and U.S. Provisional Application No. 62/417,716, filed Nov. 4, 2016, both of which are hereby incorporated by reference.

### TECHNICAL FIELD

The present invention generally relates to the improvement of spray bottles, as well as other cleaning devices, which may be used for cleaning unwanted substances or contaminants from surfaces.

### BACKGROUND

Part of one's daily routine often includes cleaning the bathroom, kitchen, rugs, and clothes. Oftentimes the contaminant one is trying to clean is elusive and difficult to accurately eliminate because it is not easily visible to the naked eye. Therefore, one will spend an excessive amount of time trying to eliminate the contaminant, may use unsanitary methods to find the contaminant such as sniffing or touching it, use an excessive amount of cleanser, and still not accomplish elimination of the offending contaminant.

Existing sprayer bottles with nozzles for cleaning either rely on human visual detection without assistance or rely on the assistance of ultraviolet (“UV”) light in flashlight form connected to the sprayer bottle and are awkward in shape and therefore difficult to use. There are flashlights on the market that use light-emitting diode (LED) UV lights for detecting pet urine, but these flashlights are not marketed for general cleaning and they do not have any ability to apply cleaner while illuminating stains. Existing sprayer bottles do not include any mechanism to help the user more easily or accurately view a contaminant. Consequently, no existing products provide the convenience, availability, or ease of use that a system employing UV lights embedded in the nozzle of a sprayer provides.

Thus, there is a need to reduce reliance on the naked eye for detecting contaminants that need to be removed or cleaned. There is also a need to eliminate the inconvenience and difficulty of use associated with locating and using a separate UV light in flashlight form with a traditional spray bottle (or other cleaning device).

### SUMMARY

Embodiments of the present invention include a battery-powered device that uses UV light bulbs embedded in the nozzle of a sprayer to detect hidden contaminants. When light emitted from the UV light bulbs is pointed at a surface or object that is to be cleaned, it illuminates certain hidden contaminants that were previously invisible or difficult to visually detect. This allows one to quickly, visually identify the contaminant, accurately apply the cleaning solution, and evaluate if the contaminant has been eliminated. Embodiments of the present invention allow for previously difficult-to-see contaminants to become easily visible, allowing the user to simultaneously spray and wipe the surface while evaluating if satisfactory cleaning was achieved.

Embodiments do not simply attach a light source to a spray bottle; rather, embodiments provide a new type of nozzle that incorporates the light source within the nozzle which also houses the battery and wiring components. Certain embodiments have an enlarged spray bottle nozzle that incorporates the light source above the channel through which cleaning fluid is dispensed and houses the battery and wiring components in the nozzle. Also, embodiments of the present invention are useful to assist a user in quickly and accurately cleaning many items found in the home, car, or other places such as hotels, schools, hospitals, etc.

One aspect of the present invention relates to a nozzle having a connector adapted to receive a container, a front surface, a channel which extends through the front surface so as to be in fluid communication with the container, wherein the channel is suitable for dispensing a fluid outwardly from the front surface, and an ultraviolet light source. The ultraviolet light source is configured to emit light outwardly from the front surface.

In another aspect, the ultraviolet light source emits light in a direction parallel to the channel where the channel intersects the front surface.

In still another aspect, the ultraviolet light source comprises one or more LED ultraviolet light bulbs.

In still another aspect, the one or more LED ultraviolet light bulbs emit ultraviolet light with a wavelength of between 365 nanometers and 385 nanometers.

In still another aspect, the UV light source emits ultraviolet light which is visible in the presence of indoor lighting.

In still another aspect, the nozzle further includes a battery compartment. The battery compartment is configured to hold one or more batteries which power the ultraviolet light source.

In still another aspect, the nozzle further includes a cover for the battery compartment. The cover is fastened by a screw.

In still another aspect, the nozzle further includes an electric circuit connected to the one or more batteries and to the ultraviolet light source and a switch which opens and closes the circuit.

In still another aspect, the switch is toggled by a slide mechanism.

In still another aspect, the nozzle further includes a trigger mechanism including a trigger, wherein the trigger mechanism is configured to cause the fluid to be dispensed from the channel in response to the trigger being depressed. The switch is toggled in response to the trigger being depressed.

In still another aspect, the ultraviolet light source comprises three or more light bulbs. The three or more light bulbs are oriented in a horseshoe shape on the front surface around the channel.

In still another aspect, the ultraviolet light source comprises three or more light bulbs. The three or more light bulbs are oriented in one or more horizontal rows on the front surface above the channel.

Additionally, the present invention relates to a spray bottle including a container suitable for holding fluid and various combinations of each of the above-described aspects.

### BRIEF DESCRIPTION OF THE DRAWINGS

The present invention will become more fully understood from the detailed description given below and from the accompanying drawings. The drawings are intended to disclose but a few possible examples of the present invention_{;} and thus do not limit the present invention's scope.

FIG. 1 shows a rear perspective view of a spray bottle with a nozzle in accordance with the present invention;

FIG. 2 shows a detail side sectional view of a nozzle in accordance with the present invention;

FIG. 3 shows a detail front perspective view of a nozzle in accordance with the present invention;

FIG. 4 shows a detail rear perspective view of a nozzle in accordance with the present invention;

FIG. 5 shows a schematic electrical diagram in accordance with the present invention;

FIG. 6 shows a detail front perspective view of a spray bottle with a nozzle in accordance with the present invention; and

FIG. 7 shows a detail front perspective view of a spray bottle with a nozzle in accordance with the present invention.

### DETAILED DESCRIPTION

The present invention generally relates to an improved nozzle for spray bottles. While preferred examples of the present invention are described in detail below in conjunction with a spray bottle, the invention is not so limited and may be applied to other types of cleaning devices such as other types of apparatus that dispense cleaning solutions.

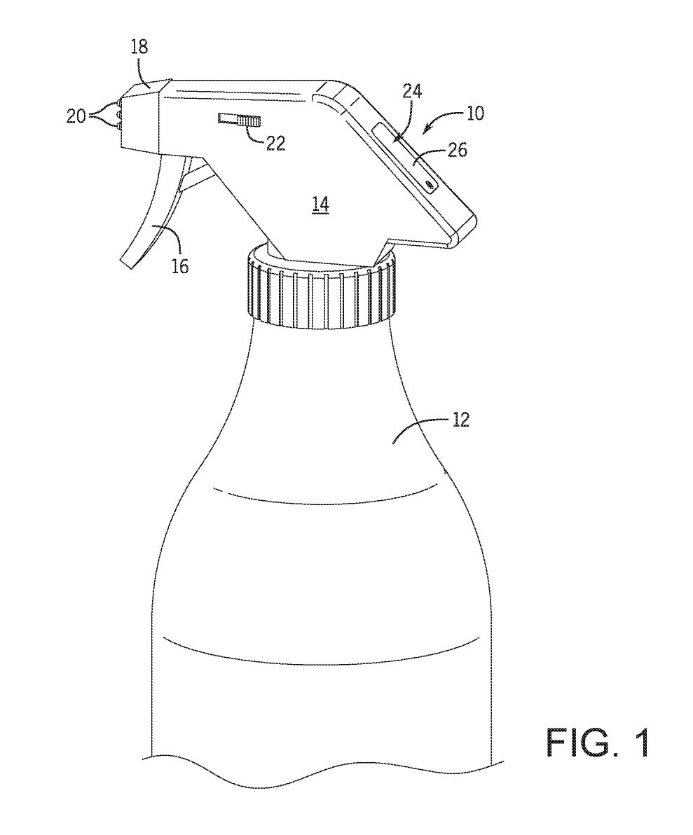

One example embodiment of an improved nozzle in accordance with the present invention is shown in FIG. 1. FIG. 1 depicts a spray bottle which includes a nozzle 14 connected to a bottle 12. The bottle 12 acts as a container for storing cleaning fluid or other fluid. The nozzle 14 is connected to the bottle 12 and functions to propel fluid stored in the bottle 12 through the nozzle cap 18. The nozzle 14 also includes a trigger 16 which when depressed, causes fluid stored in the bottle 12 to be propelled through the nozzle cap 18. Trigger 16 may accomplish this by operating a pump within the housing of the nozzle 14. Trigger 16 could also operate a valve mechanism that releases pressurized fluid such as in an aerosol type can or other similar dispensing device. Trigger 16 may be constructed from plastic, metal or other materials. In place of a trigger could be a push button, or other manual means of spraying as well as an automated means of spraying.

Nozzle 14 further includes UV light bulbs 20, which function as a UV light source, located on a front surface of the nozzle cap 18. The arrangement of UV light bulbs 20 will be described in further detail below. Nozzle 14 further includes a battery compartment 24 to contain the power source for the UV light bulbs 20. The power source may be button cell batteries but could also be a cavity for any type of battery such as (but not limited to) AA, AAA, re-chargeable, prismatic cell, pouch cell, cylindrical cell, carbon zinc, alkaline, lithium cells, silver oxide cells, zinc air cells, nickel-cadmium, nickel-metal hydride, lithium ion, lead, acid, or any other type of battery. The power source may also include alternative sources of power such as (but not limited to) a solar power strip, rechargeable power source, cord to plug in to outlet (for recharging or direct power), and other energy sources.

Nozzle 14 also includes a power switch 22 for turning the UV light bulbs 20 on and off. Power switch 22 may be a sliding switch, as shown, or it could also be a button, dial, toggle, or any other type of device to turn the UV light source on and off. Alternatively, turning the UV light bulbs 20 on and off could be automated. Other embodiments may be configured such that trigger 16 is responsible for turning the UV light bulbs 20 on or off, in addition to causing dispensation of fluid. For example, a single full depression, or other motion, of trigger 16 may turn on the UV light bulbs 20. A similar motion or other motion of trigger 16 may thereafter turn off the UV light bulbs 20.

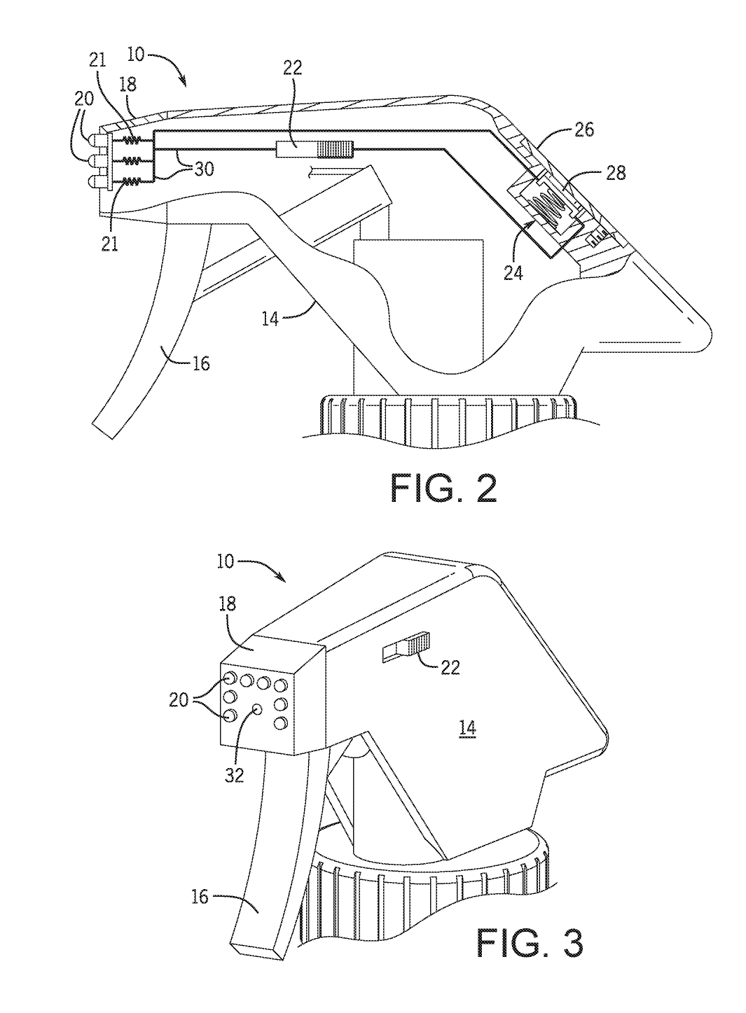

FIG. 2 depicts a section view of nozzle 14. Battery 28 is located within the battery compartment 24 and is connected to the UV light bulbs 20 via a circuit located within the housing of nozzle 14. Power switch 22 is located on the circuit and is configured to toggle power transmission from the battery 28 to the UV light bulbs 20. The circuit further includes a metal plate 30 to which the UV light bulbs 20 may be connected in parallel. Resistors 21 may be situated between the UV light bulbs 20 to regulate the current flowing to the UV light bulbs 20.

FIG. 3 depicts a front perspective view of the nozzle 14 and includes an example configuration of the UV light bulbs 20. UV light bulbs 20 are secured to nozzle cap 18 and may be embedded in the nozzle cap 18 in a manner such as residing in through-holes, for example. UV light bulbs 20 may alternatively be secured to the nozzle cap 18 or the nozzle 14 in other suitable ways. Nozzle cap 18 may be made from plastic and take a square shape, but could use other materials such as metal and could be any shape or size.

Channel 32 passes through nozzle cap 18. Channel 32 is a conduit for fluid stored in, for example, a bottle attached to nozzle 14. When fluid is dispensed from nozzle 14, it may flow through channel 32 in a direction substantially perpendicular to a front surface of nozzle cap 18. Preferably, UV light bulbs 20 are oriented such that they emit light in substantially the same direction as the direction of fluid dispensing via the channel 32. When oriented this way, the UV light bulbs 20 emit UV light in the direction of a targeted stain or contaminant. In a preferred embodiment, six to twelve UV light bulbs 20 are employed. The UV light bulbs 20 may be arranged on the nozzle cap 18 so as to surround the channel 32 in a horseshoe shape, as shown in FIG. 3, or other shape.

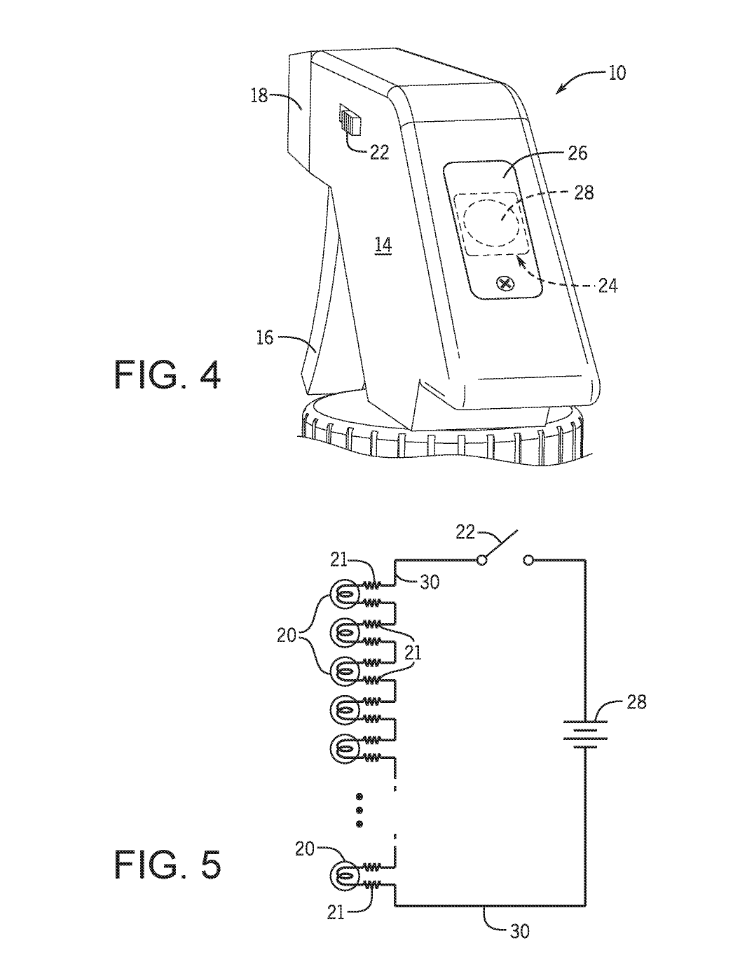

FIG. 4 depicts a rear perspective of the nozzle 14, showing the battery compartment 24 in greater detail. Battery compartment 24 includes a cover 26 which may be fastened by a screw to ensure small children cannot access batteries and that they do not otherwise fall out easily. The battery cover could be made in various shapes and forms and could also be secured in various different manners including via clips, snaps, or any other suitable mechanism.

FIG. 5 depicts a schematic diagram of an example circuit within the nozzle for powering the UV light bulbs 20. In one embodiment, each of the UV light bulbs 20 is connected to a metal plate 30 with copper (or other metal) wiring in a series circuit and to a copper (or other metal) spring that will complete the circuit when the device is turned on. The UV light bulbs 20 may also be connected in a parallel circuit, as shown implemented in the nozzle in FIG. 2. One or more resistors 21 may be attached to each of the UV light bulbs 20 to regulate the flow of electrons and to ensure the brightness is controlled and even for each of the UV light bulbs 20. These components can be put together in any order and the location for the batteries and light source could be different. Different numbers of UV light bulbs may be used. The invention could also be composed without resistors.

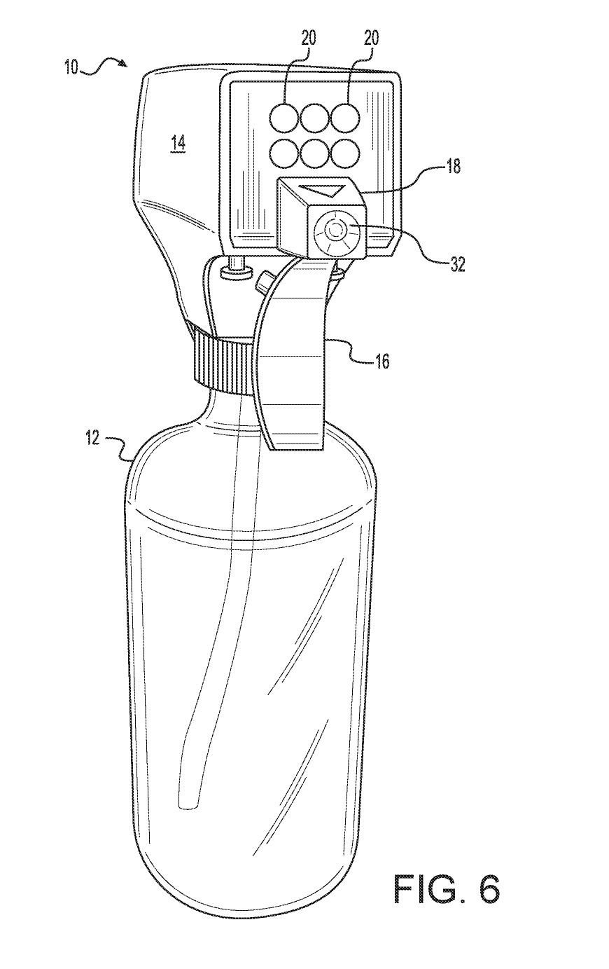

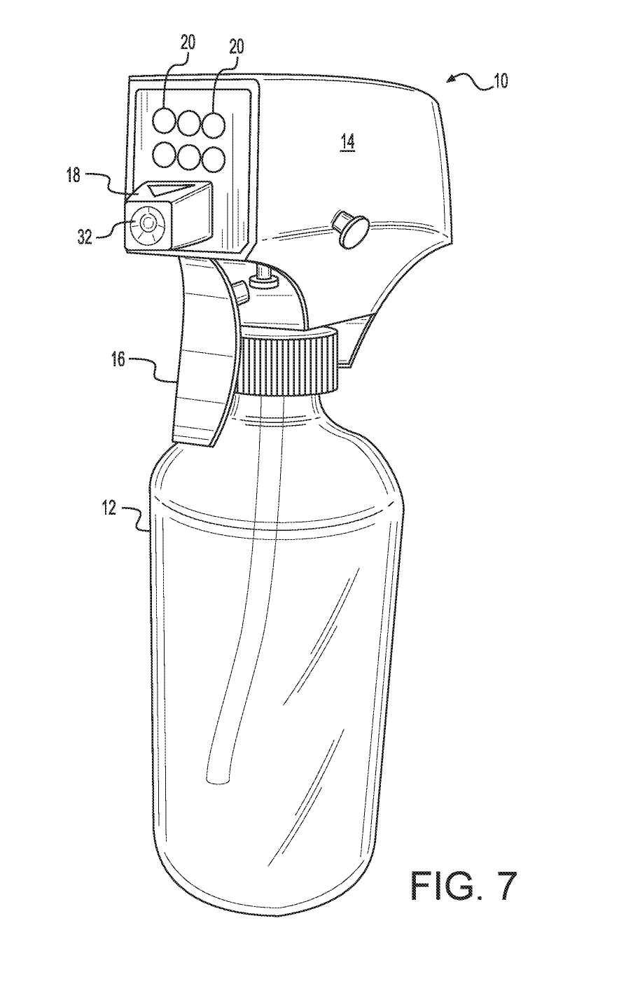

As shown in FIGS. 6-7, an alternative embodiment may include a nozzle 14 with a larger body to house a larger power source such as multiple AAA type batteries (regular or rechargeable), for example. As further shown, such an embodiment may include a nozzle cap 18 which is attached to a front-facing surface of nozzle 14. In this embodiment, UV light bulbs 20 are attached to the front-facing surface rather than to the nozzle cap 18. In a particular embodiment, UV light bulbs 20 may be oriented above the nozzle cap 18 relative to the bottle and be arranged in two or more parallel, horizontal rows.

The embodiments shown in FIGS. 6-7 may also include batteries placed in the battery compartment and in contact with terminals. As with the embodiment described above with reference to FIGS. 1-5, a cover to the battery compartment may be screwed into place of fastened by any other suitable mechanism. Likewise, copper insulated (or uninsulated) wiring may be used to connect the UV light bulbs 20 to each other and put them in contact with a power switch which will close the circuit when in the “on” position. The power switch may be a sliding switch shown in FIGS. 1-4, a push-button, or other mechanism.

A preferred embodiment of the present invention may be comprised of between six and twelve LED UV light bulbs that emit light with a wavelength of 365-385 nanometers (nm), but any number of bulbs or one bulb could be used and may emit light with wavelengths ranging from 180-400 nanometers (although some UV light is harmful and really should not be used below 315 nm wavelengths at the lowest). Additionally, any source of UV light could be used with the present invention including LED, fluorescent, mercury vapor, lasers, or incandescent. Pre-lit UV lights could also be used which would eliminate a need for any type of additional battery. Any other device or object that emits UV light could be used. In certain embodiments, UV light bulbs emit light having a wavelength that permits the device to be used without turning overhead or other room lights (e.g., incandescent, fluorescent or other room lights) off (i.e., the wavelength of the UV light is chosen so that the UV light will visibly light up the contaminant even with overhead or other room lights on).

A spray bottle in accordance with the present invention could be made by blow molding and injection molding. The bottle containing fluid could be made using blow molding. The improved nozzle could be made using an injection mold. The UV light bulbs (or other UV light source) are wired as described above and in contact with the power switch. Any process that attaches the UV light source to the spray bottle could be used. The spray bottle is filled with desired cleaning solution. Once batteries are inserted, the device is ready for the user to use.

The UV light source may be embedded or attached to the spray bottle head, in the body or trigger, or anywhere else on the spray bottle and would perform substantially the same function, as long as the UV light is emitted in a similar direction as the direction in which fluid is dispensed. The wiring or other circuitry may be formed in the plastic of the nozzle before the UV light source is attached or embedded. Embodiments may also employ a solar type panel or a plug for an external power source and perform a similar function. If the spray bottle was a pump bottle, aerosol-type can, or any other vessel that can hold cleaning solutions or materials it would perform a similar function. The power switch could be a push button or could be eliminated if pre-lit UV lights were used.

A reflector could be added to the nozzle to cause the light to shine more evenly and improve visualization of hidden contaminants. A lens could also be added over the bulbs to protect the bulbs from breaking and getting wet.

To use a spray bottle in accordance with the present invention, a battery is preferably placed in the battery compartment in the nozzle. To turn on the UV light source, the power switch is set to the “on” position which completes the circuit and causes the UV light bulbs to emit light. The user may then point the spray bottle at the surface he or she desires to clean and immediately visualize previously hidden contaminants once they are illuminated by the UV light source. The user simply pulls the trigger to spray the cleaning solution at the desired area on the surface and wipes it clean. The user is able to simultaneously evaluate if the (now visible) contaminant has been satisfactorily eliminated or if the cleaning effort needs to continue.

When using certain embodiments of the present invention, one may dim the ambient lighting in the room (total darkness is not necessary), turn the power switch on the nozzle to the “on” position, and shine the UV light source at the surface to be cleaned. The contrast of the UV-lit surface against the darkened room improves the visibility of the surface and contaminants. The user then sprays the surface and wipes it clean while simultaneously evaluating if previously hard-to-see contaminants are being wiped away. In other embodiments, a UV light source may be used that emits UV light visible in the presence of ambient, indoor lighting, which would include incandescent, fluorescent or other lights typically used to illuminate human-occupied rooms and structures. The use of such embodiments does not require dimming of the overhead or other room lights in order to see the UV light source projected onto a contaminant. With such embodiments, a user can conveniently identify and spray contaminants without first dimming or turning off the ambient lighting.

The UV light mechanism described herein may also be incorporated into and used with other types of devices. For example, mops including spray mops, twist mops, roller mops, squeeze mops, spin mops, flat mops, sponge mops and similar or related hard floor cleaning devices may incorporate a UV light mechanism such as the mechanisms shown and described above. Likewise, a UV light mechanism may be incorporated into a vacuum, carpet shampooer, carpet steamer, or other carpet/rug cleaning device. Similarly, a UV light mechanism may be incorporated into other cleaning devices, such as toilet brushes, toilet mops, scrub brushes, carpet brushes, spotting brushes, sponge devices, etc., or virtually any cleaning device that sprays or does not spray. In all of these examples, a UV light mechanism may be positioned on an end of cleaning device with a UV light source positioned to shine on floor, toilet bowl, carpet, counter, or other surface being cleaned, in front of a cleaning mechanism (e.g., mop, brush, vacuum, etc.). For some devices, the power switch for the UV light mechanism may be situated at top end of cleaning device, near or on a handle of the device, so that user does not have to bend over or reach far to turn on the UV light source. The UV light source may be turned on (and off) in conjunction with the power switch for the particular cleaning device (e.g., vacuum or carpet shampooer power switch). As a specific example of the present invention's applicability to other device, a spray mop sprayer may incorporate a UV light mechanism into the sprayer nozzle, similar to the mechanisms shown in FIGS. 1-4 or FIGS. 6-7 (either of which may incorporate circuitry shown in FIG. 5). Such a sprayer may be electronically powered, and power supply for the sprayer may provide power for the UV light mechanism as well.

Additionally, this invention could be used for pest control as certain pests such as scorpions can be illuminated when exposed to UV light. A spray bottle administering pest control spray and including a UV light source could be used to spray scorpions. It could be used in any cleaning industry including (but not limited to) rug cleaning, general purpose cleaning, car detailing, and laundry. It could be used as a robot type invention where the spray bottle is able to turn the UV light on itself and when it senses a contaminant it automatically dispenses the cleaning solution.

While various embodiments have been described, other embodiments are plausible. It should be understood that the foregoing descriptions of various examples of improved nozzles are not intended to be limiting, and any number of modifications, combinations, and alternatives of the examples may be employed.

The examples described herein are merely illustrative, as numerous other embodiments may be implemented without departing from the spirit and scope of the present invention. Moreover, while certain features of the invention may be described above only in the context of certain examples or configurations, these features may be exchanged, added, and removed from and between the various embodiments or configurations while remaining within the scope of the invention.

We claim:

1. A nozzle, comprising:
a connector adapted to receive a container;
a front surface;
a channel which extends through the front surface so as to be in fluid communication with the container, wherein the channel is suitable for dispensing a fluid outwardly from the front surface; and
an ultraviolet light source, wherein the ultraviolet light source is configured to emit light outwardly from the front surface.

2. The nozzle of claim 1, wherein the ultraviolet light source emits light in a direction parallel to the channel where the channel intersects the front surface.

3. The nozzle of claim 1, wherein the ultraviolet light source comprises one or more LED ultraviolet light bulbs.

4. The nozzle of claim 3, wherein the one or more LED ultraviolet light bulbs emit ultraviolet light with a wavelength of between 365 nanometers and 385 nanometers.

5. The nozzle of claim 1, wherein the UV light source emits ultraviolet light which is visible in the presence of indoor lighting.

6. The nozzle of claim 1, further comprising:
a battery compartment, wherein the battery compartment is configured to hold one or more batteries which power the ultraviolet light source.

7. The nozzle of claim 6, further comprising:
a cover for the battery compartment, wherein the cover is fastened by a screw.

8. The nozzle of claim 6, further comprising:
an electric circuit connected to the one or more batteries and to the ultraviolet light source; and a switch which opens and closes the circuit.

9. The nozzle of claim 8, wherein the switch is toggled by a slide mechanism.

10. The nozzle of claim 8, further comprising:
a trigger mechanism including a trigger, wherein the trigger mechanism is configured to cause the fluid to be dispensed from the channel in response to the trigger being depressed; and
wherein the switch is toggled in response to the trigger being depressed.

11. The nozzle of claim 1, wherein the ultraviolet light source comprises three or more light bulbs; and
wherein the three or more light bulbs are oriented in a horseshoe shape on the front surface around the channel.

12. The nozzle of claim 1, wherein the ultraviolet light source comprises three or more light bulbs; and
wherein the three or more light bulbs are oriented in one or more horizontal rows on the front surface above the channel.

13. A spray bottle, comprising:
a container suitable for holding a fluid; and
a nozzle, the nozzle comprising:
a connector adapted to receive the container;
a front surface;
a channel which extends through the front surface so as to be in fluid communication with the container, wherein the channel is suitable for dispensing the fluid outwardly from the front surface; and
an ultraviolet light source, wherein the ultraviolet light source is configured to emit light outwardly from the front surface.

14. The spray bottle of claim 13. Wherein the ultraviolet light source emits light in a direction parallel to the channel where the channel intersects the front surface.

15. The spray bottle of claim 13, wherein the ultraviolet light source comprises one or more LED ultraviolet light bulbs.

16. The spray bottle of claim 15, wherein the one or more LED ultraviolet light bulbs emit ultraviolet light with a wavelength of between 365 nanometers and 385 nanometers.

17. The spray bottle of claim 13, wherein the UV light source emits ultraviolet light which is visible in the presence of indoor lighting.

18. The spray bottle of claim 13, further comprising:
a battery compartment, wherein the battery compartment is configured to hold one or more batteries which power the ultraviolet light source.

19. The spray bottle of claim 18, further comprising:
an electric circuit connected to the one or more batteries and to the ultraviolet light source; and
a switch which opens and closes the circuit.

20. The spray bottle of claim 19, wherein the switch is toggled by a slide mechanism.
